(19) United States
(12) Patent Application Publication
(10) Pub. No.: US 2016/0232582 A9
(43) Pub. Date: Aug. 11, 2016

(54) METHOD AND SYSTEM FOR NUMBER SEARCHING AND DISPLAYING REQUESTED TELEPHONIC NUMBERS

(71) Applicant: WILLIAM QUIMBY, Salt Point, NY (US)

(72) Inventor: WILLIAM QUIMBY, Salt Point, NY (US)

(21) Appl. No.: 14/260,224

(22) Filed: Apr. 23, 2014

Related U.S. Application Data
(60) Provisional application No. 61/814,884, filed on Apr. 23, 2013.

(51) Int. Cl. G06Q 30/02

(52) U.S. Cl. CPC G06Q 30/0283

(57) ABSTRACT

The present invention is for a method and system for a web-based platform for request submissions and management of telephonic numbers. Users enter particular numbers and determine a value or a range of values for such telephone number(s). User input portals and data processing centers allow a number value that represents what someone would pay a third party telephone number owner to give up that telephone number, or for which the third party telephone number owner might sell such telephone number. Should a user desire, for example, via a wish list process or request a number may be selected and reserved for a user and designated and then transferred to a local telephone provider. Other aspects improve convenience, allow manipulation of number valuation, provision of a promotional number reservation system, and a brokerage reservation system for a number that may not be available for immediate transfer to a desired user.

### CROSS REFERENCE TO RELATED APPLICATIONS

This application relates to and claims priority from U.S. Prov. Ser. No. 61/814,884 filed Apr. 23, 2013, the entire contents of which are incorporated herein fully by reference.

### FIGURE SELECTED FOR PUBLICATION

FIG. 1

### BACKGROUND OF THE INVENTION

1. Field of the Invention

The present invention relates to a method and system for allowing users to search for availability of and value information regarding telephone numbers and the related host data processing system. More particularly, the present invention pertains to a web-based application that allows a user to search for availability of telephone numbers across multiple area codes (including, without limitation, alphanumeric and derivative versions), and assigns/displays values associated with such numbers, and in some cases assists users in requesting, acquiring and/or setting up those potential numbers with phone companies and/or from end users.

2. Description of the Related Art

Currently, telephone companies and other telephone providers typically charge a flat fee for setting up new telephone numbers; however, such telephone companies do not know (or may not care as it relates to their different business model) what an actual likely value of such telephone numbers could be to a user. Such providers generally charge the same fee for any telephone number, because providers typically have no reliable source for relative values of different telephone numbers.

In the past, and still currently, existing telephone companies (e.g. ATT®, NEXTEL®, SPRINT®, etc.) typically issue numbers to their customers for the purpose of selling telephone service. While this model established when each respective telephone company had their own exclusive set of telephone numbers. Now, portability of telephone numbers has changed the industry considerably. With telephone number portability, a telephone customer may now start with one telephone service provider and then switch to another telephone provider after getting a desirable telephone number. Therefore, from the perspective of existing telephone companies, a good number no longer insures a good customer to a telephone company.

Further, conventional telephone companies/providers are generally not capable of searching for desired local vanity numbers. Moreover, such local telephone companies/providers frequently don't know whether particular telephone numbers may have variable values, how to find related numbers (or numbers that are not under their control), and they generally cannot help locate or secure available telephone numbers of other telephone companies, or even numbers held by existing customers. All these factors make the current process of acquiring a number and accessing a marketable value of any such number very difficult for both a user and a telephone company.

Local telephone companies typically only look at and have information regarding those particular numbers that they have already been assigned to them (e.g., 212-345-6789), or a smaller subset of the numbers already assigned thereof, which is typically just a tiny fraction of billions of potential telephone number combinations.

A general overview of the telephone numbering arrangements, blocks, and concerns for addressing 10-digit dialing patterns in the format NXX-NXX-XXXX, where “N” represents any digit 2-9 (eight digits) and “X” represents any digit 0-9 (ten digits), may be seen from the Third Report and Order and Second Order on Reconsideration CC Docket No. 96-98 and CC Docket No. 99-200 released Dec. 28, 2001 by the Federal Communications Commission, report FCC 01-362, a copy of which is herein incorporated fully by reference. The North American Numbering Plan (NANP) was established long ago and sets forth the above numbering scheme. The first three digits represent the Numbering Plan Area (NPA) the area code, the second three digits represent the Central Office or exchange, and the last four digits represent the subscriber line number. Broadly speaking this report outlines the general numbering administration policies, number blocks and pooling policies and practices, take-back policies, dialing overlays and related telephony systems and understandings to this general field.

Unfortunately, as is noted above, local telephone companies do not consider: (i) numbers not yet assigned, (ii) numbers assigned to other phone companies, (iii) numbers already in use for other customers or (iv) any previous requests or user behavior. Additionally, local telephone companies will generally only search within their existing database(s) for an exact match for a requested telephone number or, at most, with a simple “wild card” search by adding characters/numbers in front of the telephone number being searched. Further, such local telephone companies generally do not know which telephone numbers may have value in the marketplace or be related.

Accordingly, there is a need for an improved method and system for number searching and displaying that addresses a further benefit or efficiency further to those above. Additionally, there is a need for the provisions of an enhanced data processing system for providing operably enabling the searching and display of data relative to one or more phone number users or requestor and or the numbers and requests related to that user or requestor.

### ASPECTS AND SUMMARY OF THE INVENTION

An aspect of the present invention is to provide an enabling method and system for addressing at least one of the concerns above.

Another aspect of the present invention is to provide an operational folder for acceptance and inter-use of data related to one or more users of the proposed method and system.

The present invention further relates to a method and system for selection and display of requested telephonic numbers.

The present invention is for a method and system for a web-based platform for submissions and management of telephonic numbers. Users enter particular telephone number and determine a monetary value or a range of values (wholesale or retail) for such telephone number(s). User input portals and data processing centers allow a number value that represents what someone would pay a third party telephone number owner to give up that telephone number, or for which the third party telephone number owner might sell such telephone number. Should a user desire, for example, via a wish list process or request a number may be selected and reserved for a user and designated and then transferred to a local telephone provider. Other aspects improve convenience; allow manipulation of number valuation, provision of a promotional number reservation system, and a brokerage reservation system for a number that may not be available for immediate transfer to a desired user.

The present invention additionally relates to a method and apparatus for searching for, displaying, requesting and obtaining telephone numbers, including local telephone numbers, to allow users to search for and select valuable local numbers that they wish to acquire, whether for use and/or marketing to third parties.

The present invention additionally relates to a method and system for administering a web-based service provided through a web site (internet portal) having a particular designated Universal Resource Locator (URL) domain name such as, for example, www.VanityNumbers.com, www.WhatsMyNumberWorth.com or www.RequestLocalNumbers.com, without limitation thereto.

In one alternative aspect of the present invention, it is possible to charge a user a fee based on a designated actual value of a telephone number (wholesale or retail), since the present invention recognizes that number portability means that a local telephone provider can often no longer count on revenue from the user. Such local telephone providers should beneficially use all means revenue available so as to remain commercially competitive, including adopting the method and apparatus of the present invention.

In another alternative aspect of the present invention, the proposed method and system also enhances the use of a valuable resource (e.g., a phone number) by making better numbers more accessible to larger users, and encouraging smaller users to take designated ‘less’ valuable numbers.

In another alternative aspect of the present invention, unlike existing practice, the present invention permits users to search for and request telephone numbers with all virtually all or any telephone companies. The present invention provides an improved search and display process than existing methods, and is not limited to just telephone numbers of a single telephone company, or small group of such companies.

According to another alternative aspect of the present invention, the method and system provides a unique national database, or series of interoperable databases, of information on all local numbers in North America is built, by calculating all of the system identified vanity words available from each number or part thereof.

In another aspect of the proposed method and system a module evaluates an assigned value of each term or phrase, and calculating a head of any number query time, a wholesale and retail value for each number, creating a central place for users to search for telephone numbers.

In another alternative aspect of the proposed method and system, users can search by designated keyword, or specify certain types of numbers, such as VOIP (voice over internet protocol), C (cellular), or L (land line), specific phone companies (ATT®, Sprint®, Verizon®, etc.) or all phone companies, and can access relative assigned values of such telephone numbers, possible vanity uses of the numbers, what telephone companies such designated numbers are currently listed with (if any), and/or whether the telephone numbers are currently active for another customer.

In another alternative aspect of the proposed method and system of the present invention, an interactive user system provides a means for users to request particular telephone numbers, as well as multiple versions of such numbers and/or related numbers. Additionally, users may also make so-called global requests, e.g., requesting a 7 digit number nationwide in ANY area code and then taking only the first accepted number, whatever area code it's in, or reserving all such numbers.

In another alternative aspect of the proposed method and system of the present invention, both users and phone companies may access a designated wholesale and/or retail value for a particular number (set by the system and method), but may also allow interested parties to make offers (a type of bidding) less than or more than the system designed fixed prices (e.g., relative to these prices or in an absolute price manner).

In another alternative aspect of the proposed method and system provides an option for presenting the offer to another other party, whether it is a phone company or an end user. The present system additionally provides an easy portal and method for anyone looking for (seeking) a particular telephone number to acquire a more valuable and more desired telephone number, particularly a local number, for their business or even personal use, even if they aren't assigned to any phone company yet or if they have already been set up for another end user.

The present invention derives values for telephone numbers based on multiple factors including, without limitation, the number of search queries or requests for telephone numbers on our sites and other sites, activation speed of ‘844’ or ‘855’ number activation when such numbers are newly released, the quantity of toll free telephone number searches or queries, the amount/volume and or ratio of telephone numbers left in a particular area code, the amount of times a telephone number shows up in a search engine, historical log files, the amount of different vanity spellings possible for a telephone number, the value of those terms, the frequency with which such spellings/terms show up in marketing materials or online searches, and the amount of other area codes in which numbers are still available.

In another alternative aspect of the present method and system, in determining valuation, additional factors can also be considered in order to derive a monetary value for telephone numbers, including custom valuations. For example, numeric value can also be considered, including factors such as repetitive digits, numbers ending or containing zeros, patterns, finger movement (relative to the normal 3×3 or 4×3 numeric key pad and the alphanumeric relationship therein), potential for wrong numbers, and overall flow of a number when spoken. For example, an interior decorator might license the phone number 1-800-724-6837 but advertise it as the more memorable phoneword 1-800-PAINTER. Sometimes businesses advertise a number with a mnemonic word having intentionally more letters than there are digits in the phone number. Usually, this means that the caller just stops dialing at 7 digits after the area code or that the numbers are ignored by the switchboard in the PSTN system (public switch telephony network).

According to other aspects of the proposed method and system, several factors may be used to calculate to the number values by area code, including the percent of potential numbers allocated, the population base in or near that area code coverage area, and the age and recognition of the area code. Any or all of this data can be compiled and factored using the proposed method and system for each of the eight (8) million possible seven (7) digit telephone numbers and for each of the 350+ area codes in North America to generate each telephone number's value including (according to the factors noted) without limitation, specific vanity or numeric value, and overall value.

According to another alternative aspect of the proposed invention is provided a method and web-based platform system wherein, users can enter particular telephone number(s) in order to determine a specific dollar value or a range of values for such telephone number(s). This value may represent what someone would likely have to pay a third party telephone number owner to give up that telephone number, or for which the third party telephone number owner might sell such telephone number. Because telephone providers typically charge a small flat fee to set up a local telephone number, telephone customers frequently don't know the value of a particular telephone number, or even realize that telephone numbers have value.

As noted above, while telephone providers typically search for a telephone number only within a specific area code, the same number is never offered or considered in multiple area codes. Therefore, the present invention alternatively provides a method and system that permits a user to search for and display multiple options including, without limitation, the status, availability and value of the same seven (7) digit number in multiple area codes.

The present invention proposes that this improved method and system provides a unique perspective on telephone number data is very valuable for customers who have multiple locations, multiple agents or multiple stores, or may want to franchise or expand their business into other areas. It is also proposed as extremely valuable for customers that don't sell locally such as a web based businesses that could use any area code, but want to reinforce their brand name locally and thus drive internet related sales. For example, when a telephone provider is asked for a specific number like 201-DENTIST, the local telephone provider does not suggest or provide information regarding availability of other variations 203-DENTIST or 978-DENTIST.

In another alternative aspect of the present invention, when a customer contacts a local telephone provider (even one covering many states is considered a ‘local provider’) to inquire about a telephone number containing a word such as “LIMO”, the telephone provider will typically search only for “***-LIMO” or “***-5466”. Telephone providers typically do not look for related or derivative terms; for example, they typically would not check for or suggest DRI-VERS or 374-8377. Such related terms can generally be found by looking at previous searches and what other terms users that search for LIMO have searched for, other keywords on websites that contain the term, synonyms, or related phrases. In other words, local telephone providers must use wild card searches by manually adding additional digits, typically in front of or behind the searched term. But local telephone providers do not actively suggest numbers with the word “SMILE” if the customer was looking for “DENTIST”. Further, the proposed invention provides by preprocessing a list of related terms for every seven digit number, if a customer enters “DRIVERS” our invention includes by considering other previous requests and then multiplying the value of the related numbers by the frequency that they came up in previous searches for that user (or for all users), the proposed method and system would determine whether to suggest other Automotive related options, Golf related options, or computer related options, all of which are related to different meanings for the word DRIVERS, as well as how to tailor their results such as whether to focus in their specific area code or to show options nationwide, regionally or in a specific set of area codes.

As another alternative aspect of the present invention, the proposed method and system may optionally, by way of illustration, allow when a user requests a number that is not available at the instant of query, additionally provide the user the option to be notified if the number is or will become available in the future for a designated time. Another aspect of our invention includes the ability to place a “watch” on or make request for individual numbers for customers in case that number gets issued in a block of numbers to a carrier, gets disconnected, becomes available for any reason, or provides a system operative to contact the number-owning-customer and solicit an offer to sell their number or attempt to facilitate a transfer to the desiring-user. The proposed system would also allow the system to attempt to secure a number on the behalf of a user if not already secured, and in some cases to continue to follow-up and request the numbers over time for a customer.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

The above and other aspects, features and advantages of the present invention will become apparent from the following description read in conjunction with the accompanying drawings, in which like reference numerals designate the same elements.

### BRIEF DESCRIPTION OF THE DRAWINGS

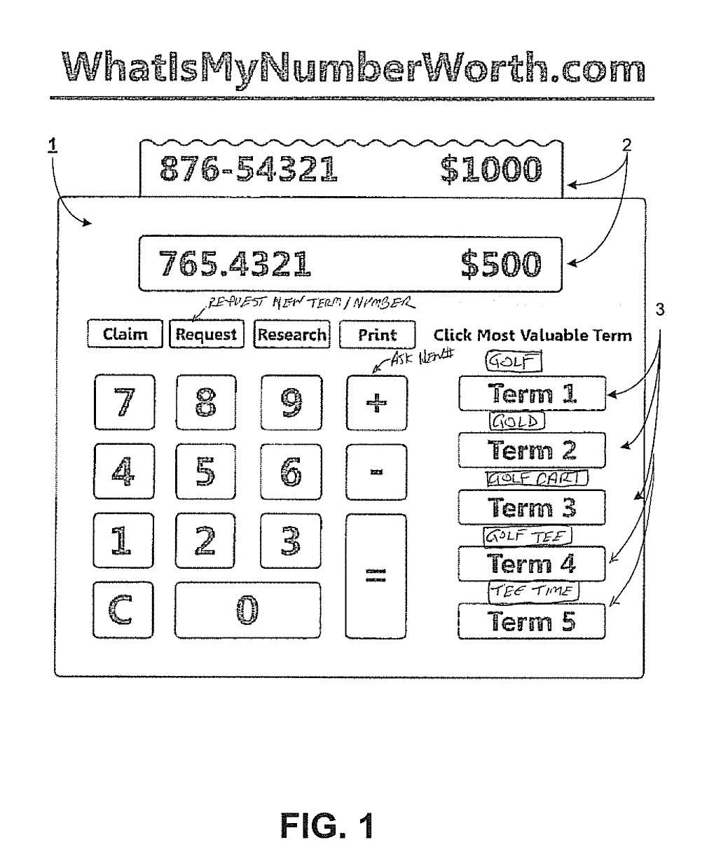

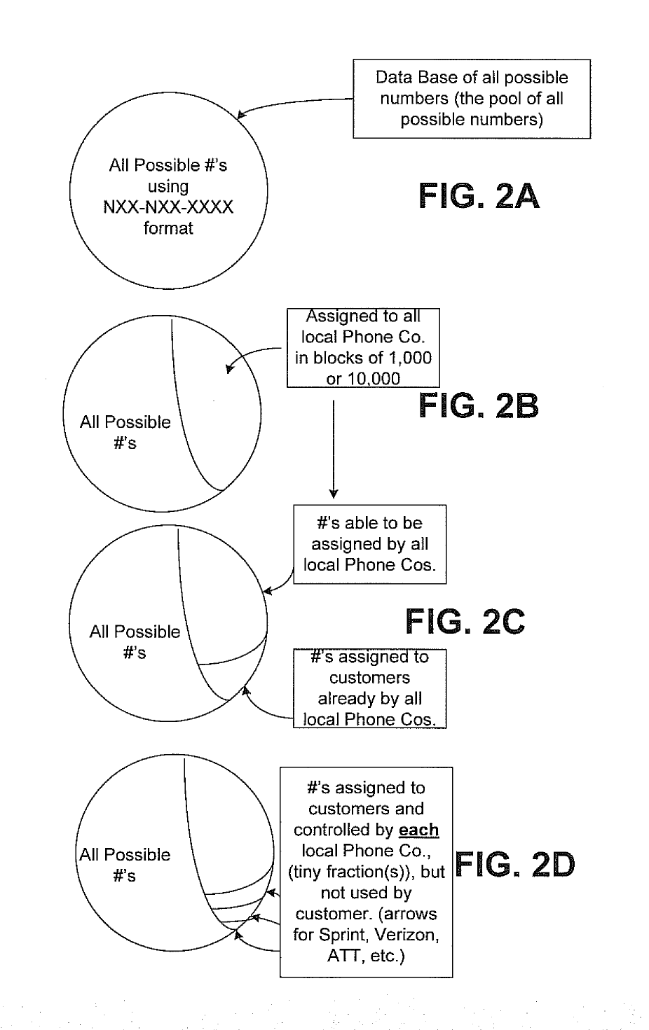

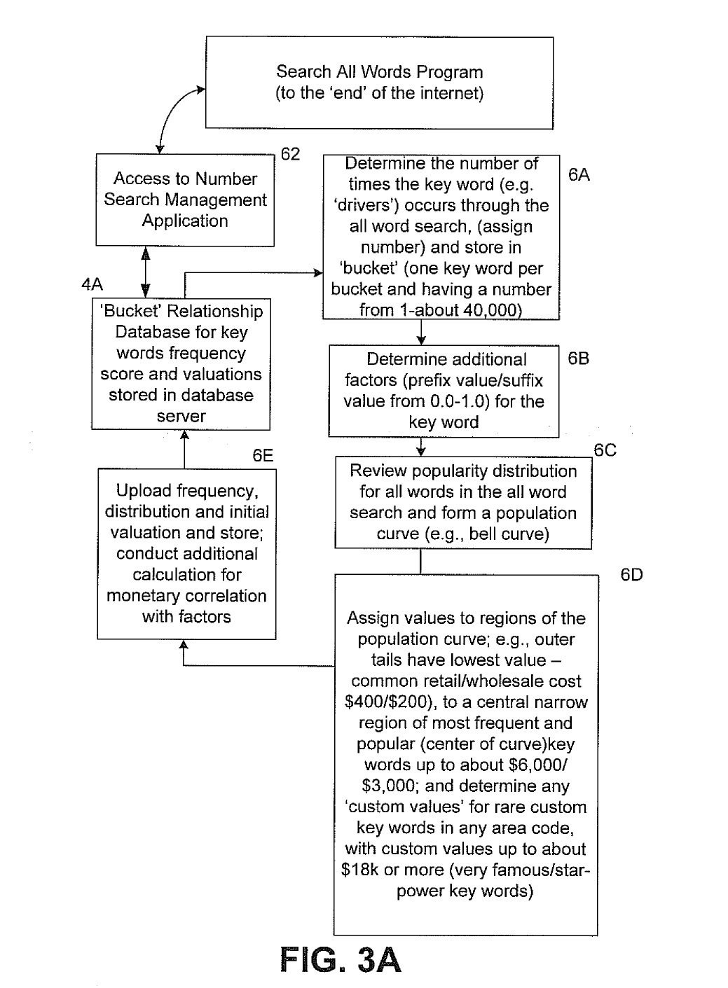

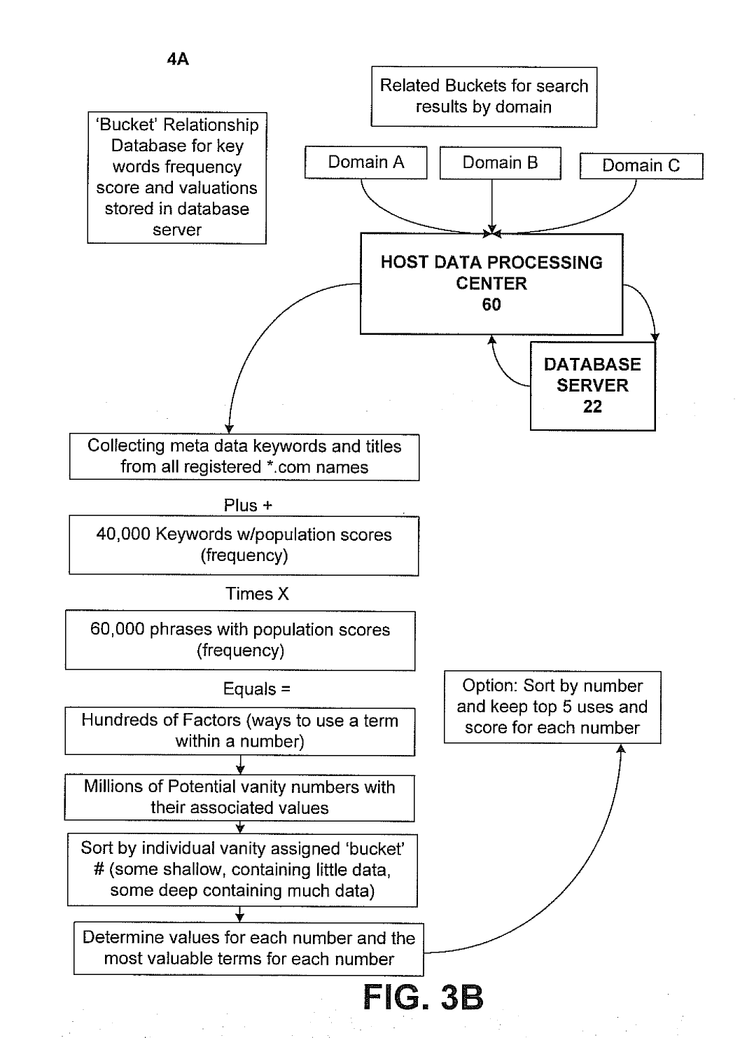

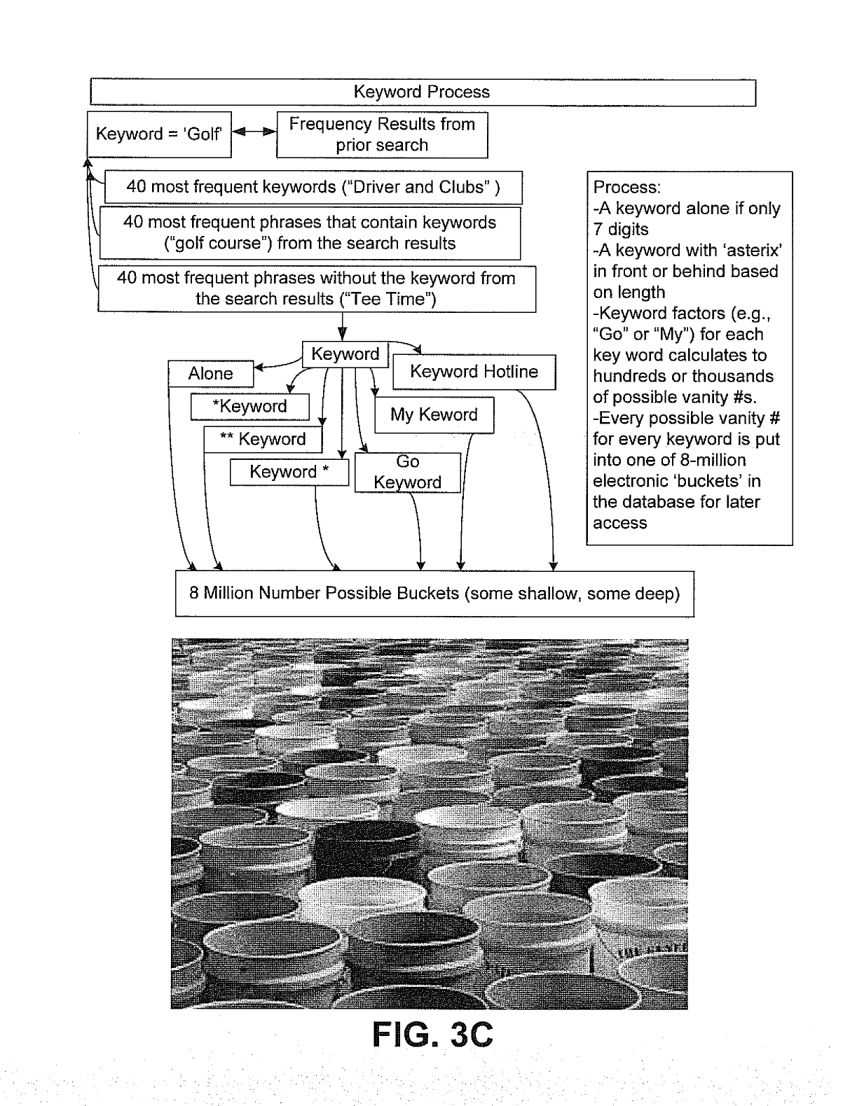

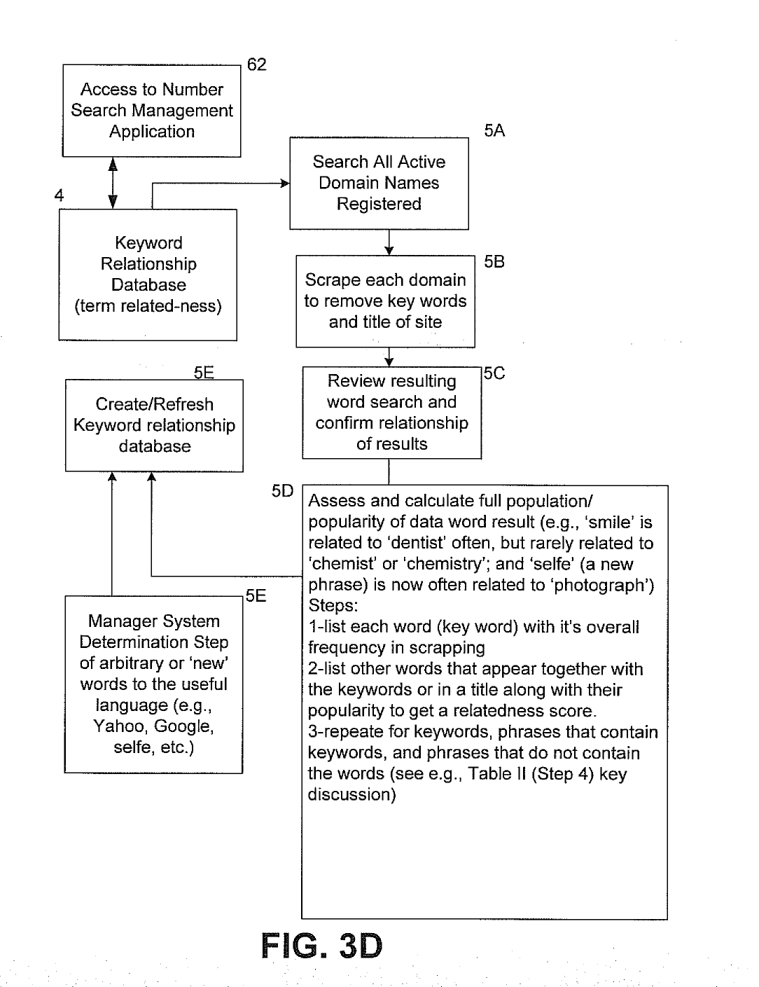

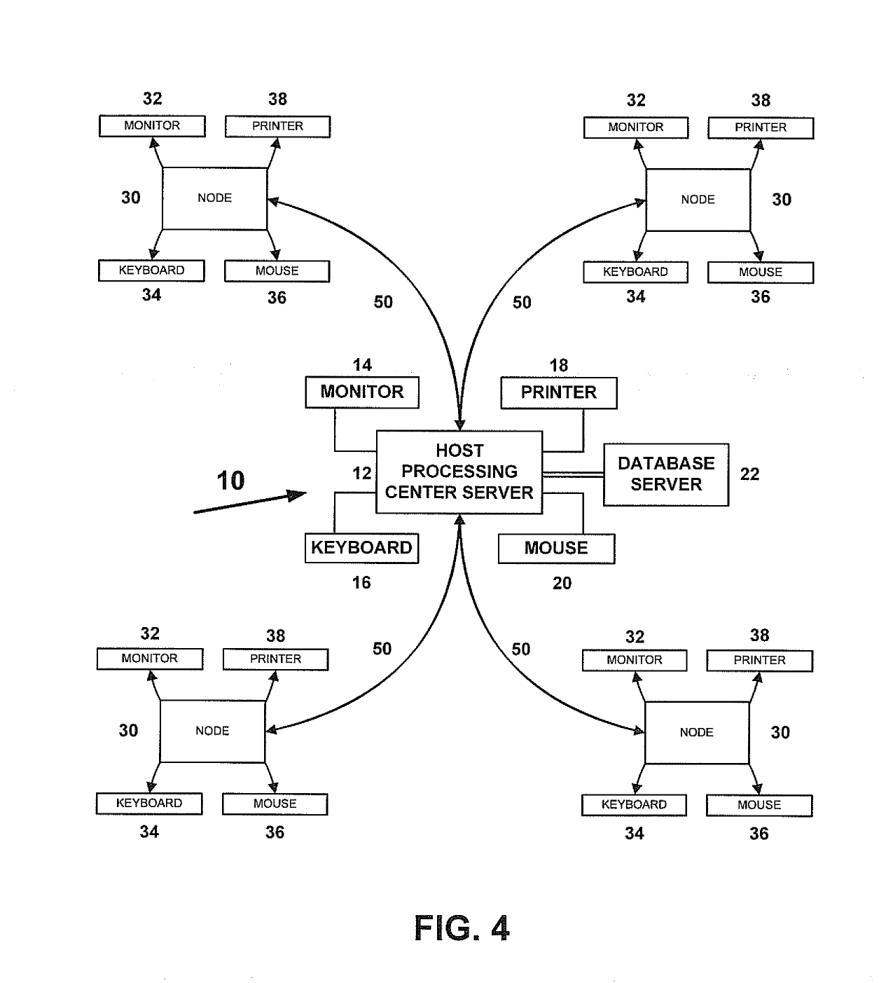

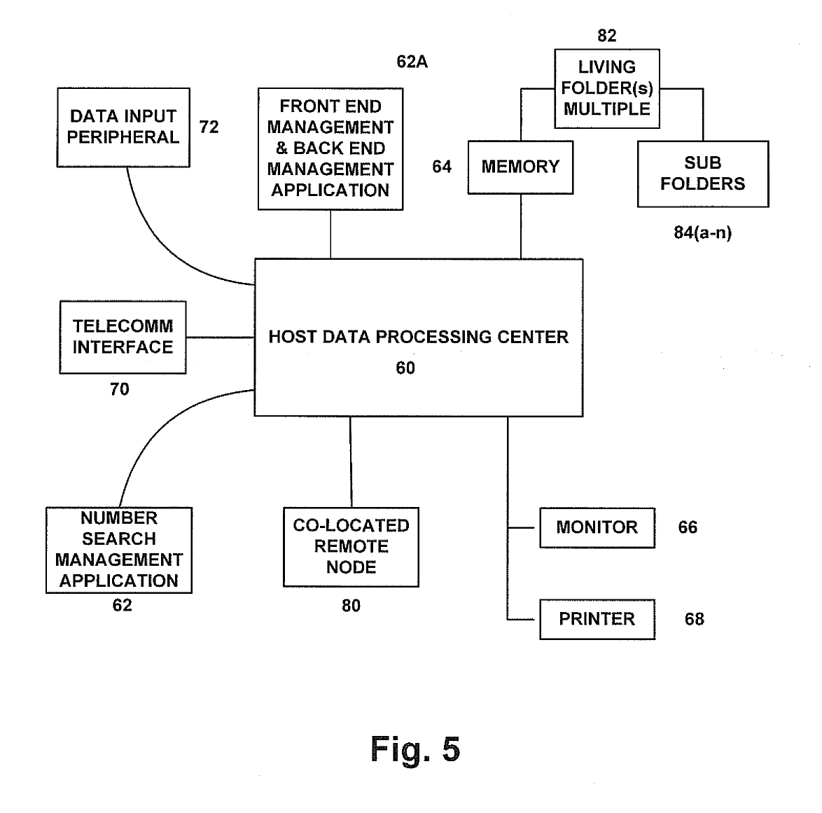

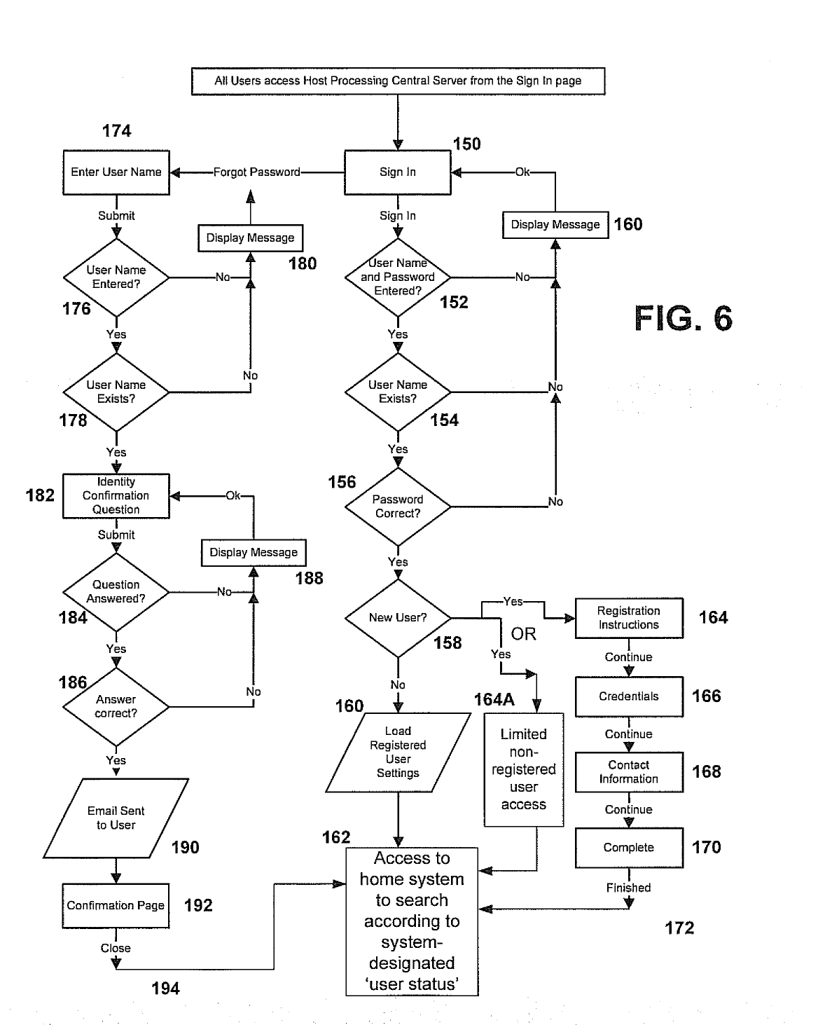

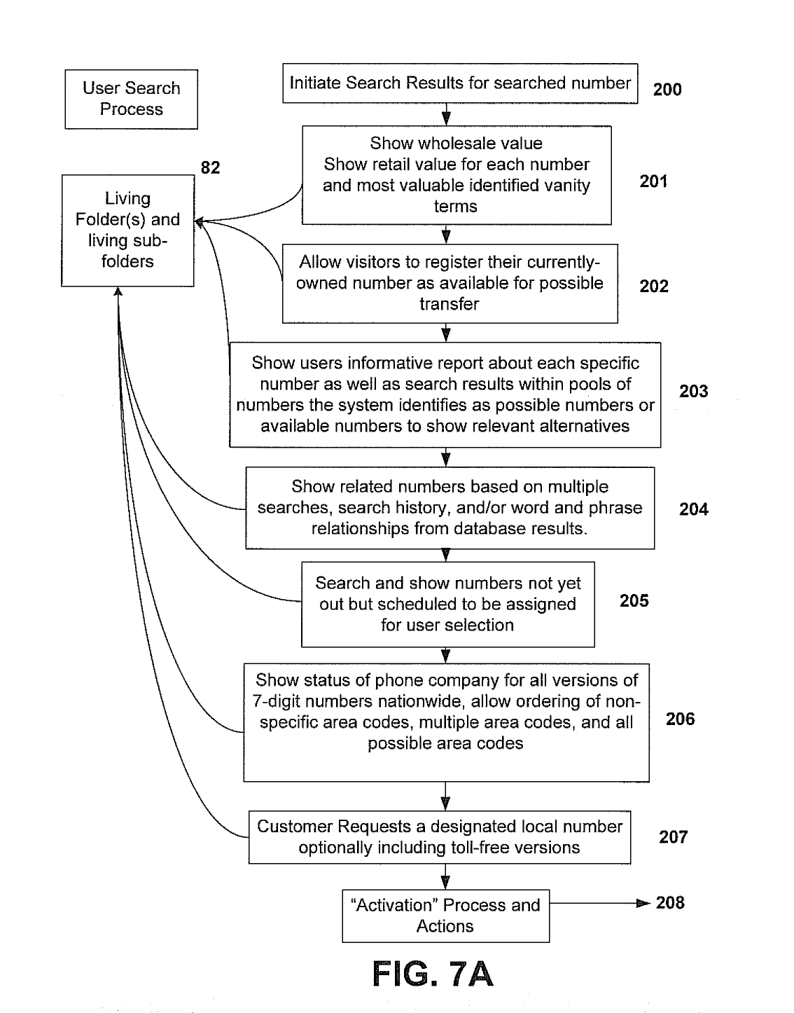

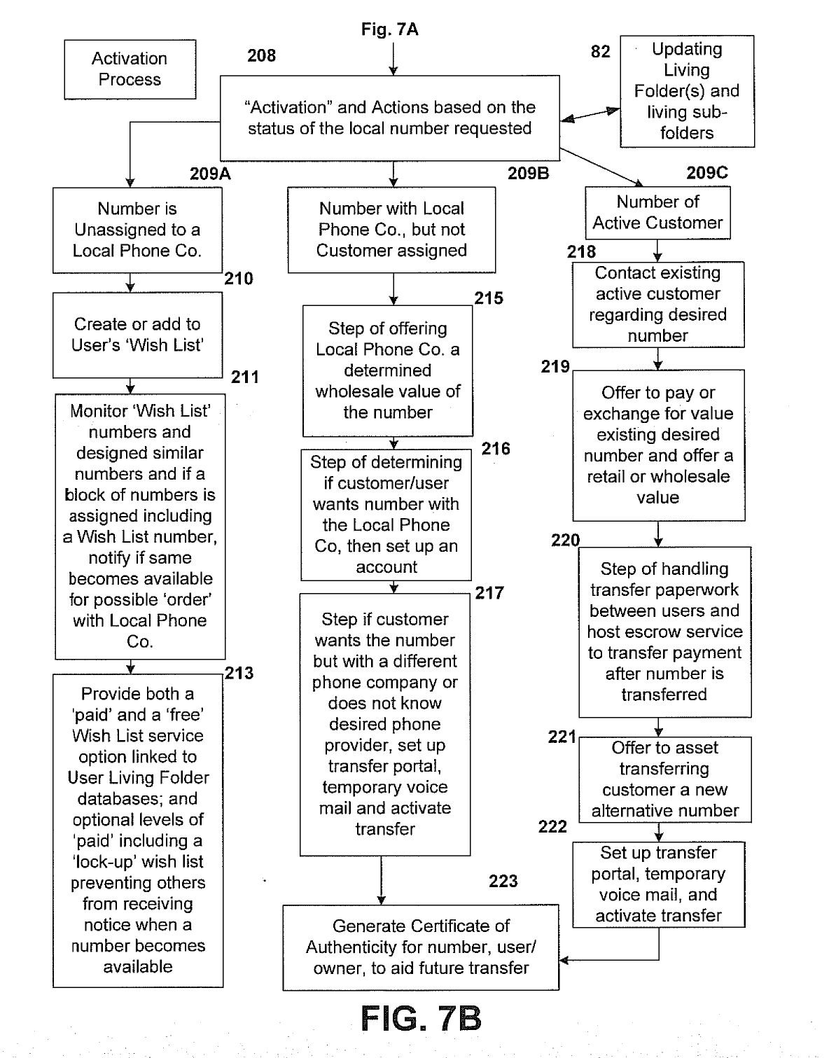

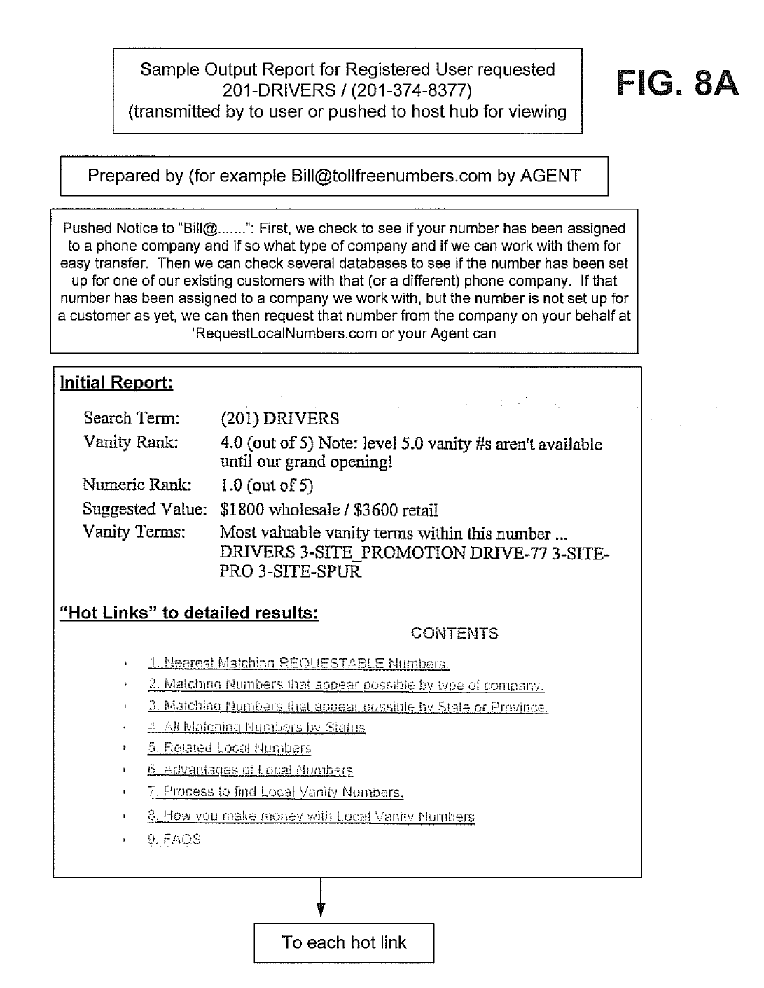

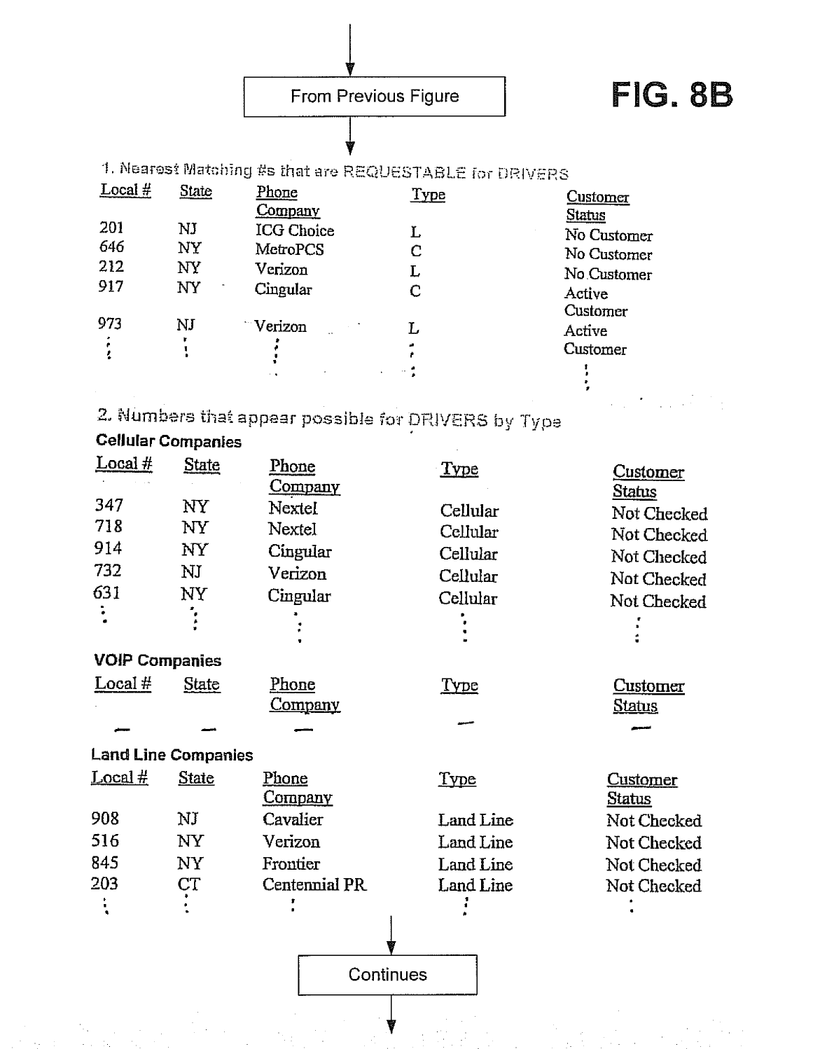

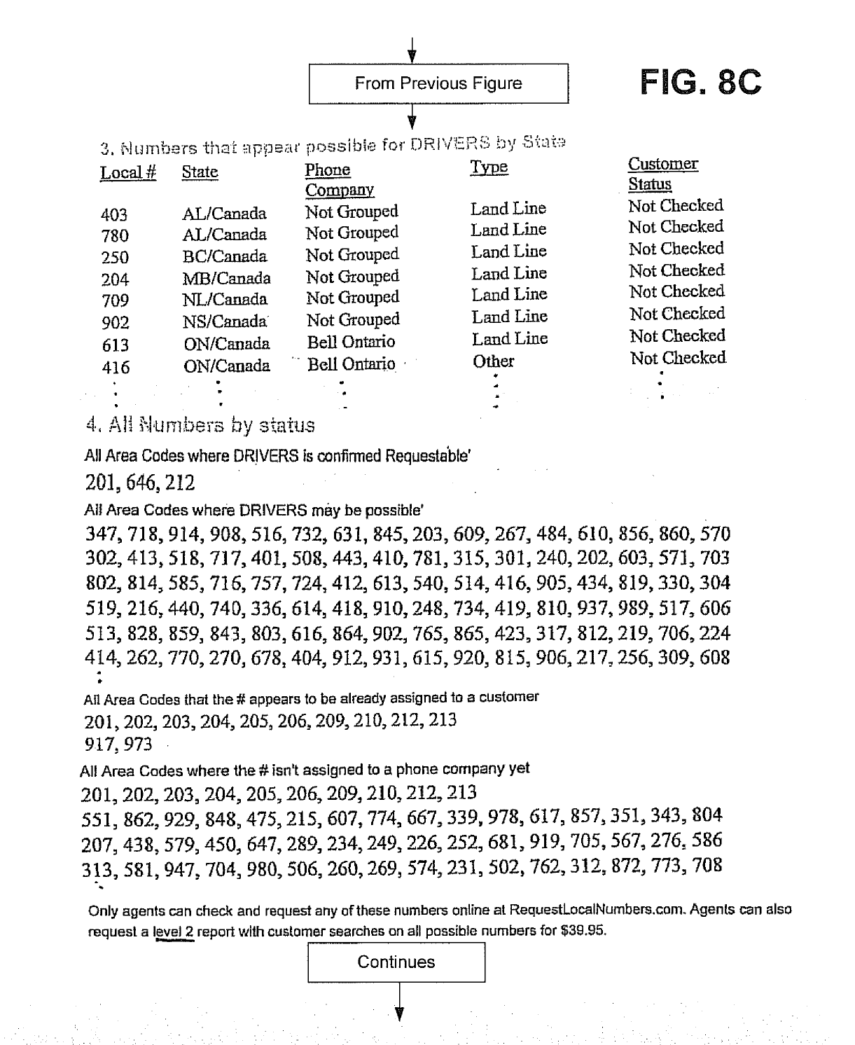

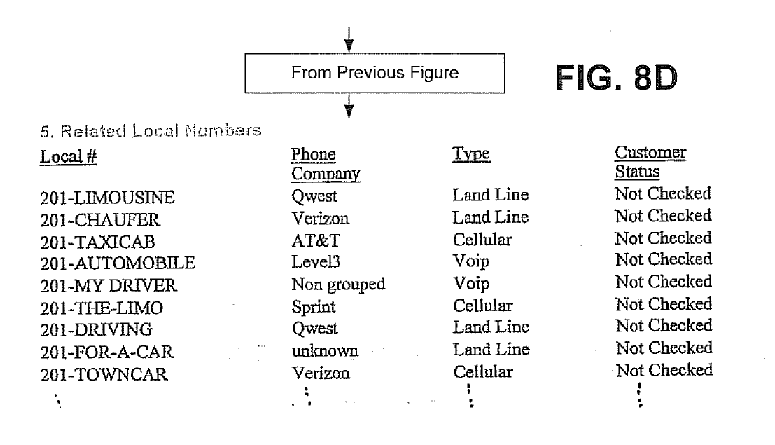

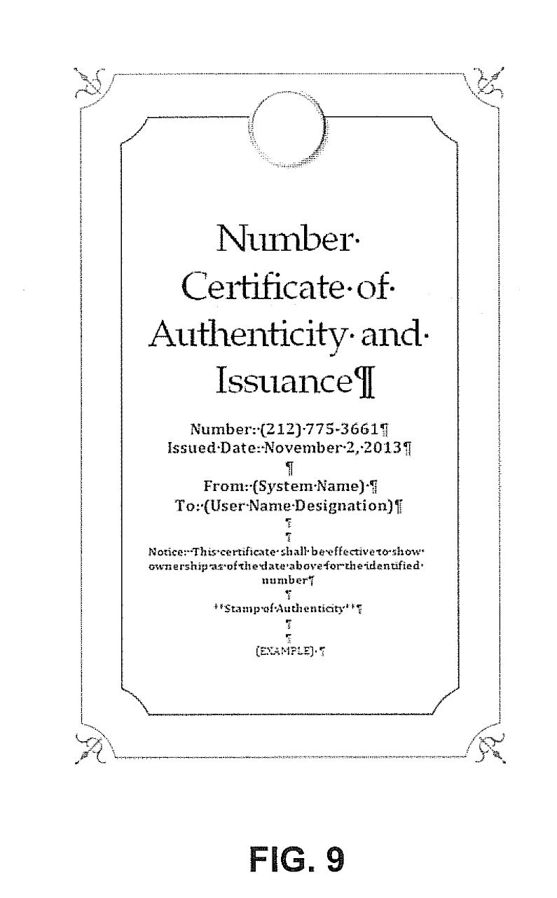

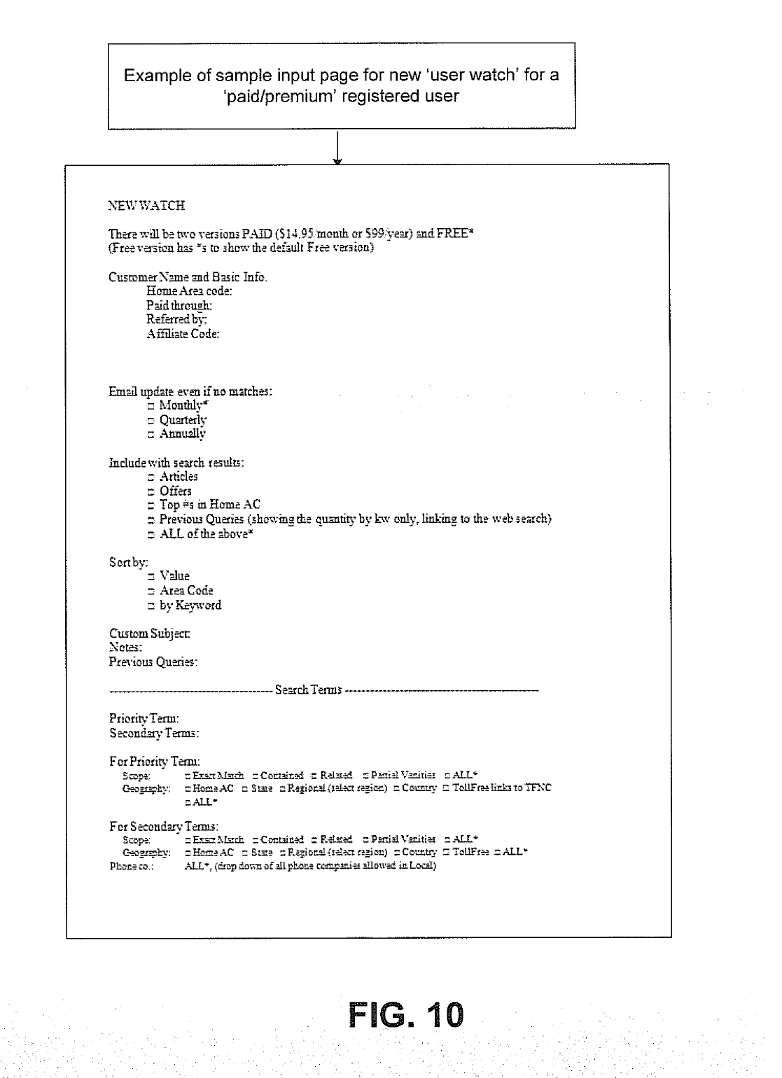

FIG. 1 is an illustrative sample user screen accessed through a user telecommunication interface and center processing server.

FIGS. 2A through 2D denote a pictorial explanation of the specific pool of numbers that are possible (FIG. 2A), of that pool, a group of numbers are assigned to phone companies (FIG. 2B), of that group of assigned numbers, a group of which are already assigned and used by specific customers (FIG. 2C), then of the remaining assigned but unused numbers, each phone company controls only a small subsection of numbers.

FIG. 3A is an exemplary flow chart of one alternative method for determining the frequency of occurrence of potential vanity words and for storing a resultant valuation of such terms.

FIG. 3B is another exemplary flow chart for developing valuations for words and for storing and factoring potential values.

FIG. 3C is another exemplary flow chart and illustration for developing valuations for words and for storing and factoring potential values.

FIG. 3D is an exemplary flow diagram of an inter-operative database development process, shown as a keyword relationship database process, which may be refreshed and reestablished on a user-desired basis, and which generally allows the proposed system to determine a most common term related-ness factor.

FIG. 4 is an upper level diagram of a system according to the present invention showing a host data processing center and exemplary nodes.

FIG. 5 is a block diagram of a host data processing center enabling operative use.

FIG. 6 is a flowchart depicting an authentication work flow for a user of various types.

FIGS. 7A to 7B provide flow charts depicting an integrated search process and activation process for a user designation with various optional outcomes.

FIGS. 8A, 8B, 8C, and 8D show an exemplary output report in accordance with the proposed method and system for searching and displaying search results for a determined number.

FIG. 9 is an exemplary Certificate of Authenticity and Origination to enable later transfer of a designated and selected customer number.

FIG. 10 is an exemplary New Watch sample input page for a registered user, illustrating the types of data that could be included in such a user-desired watch or ‘wish list’ request.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description or the elements described should not be construed to imply that these operations are order dependent or that all elements are required for the invention.

FIG. 1 is provided as an exemplary sample user screen display 1 accessed through a user telecommunication interface (here www.whatismynumberworth.com) and center processing server, as will be discussed. Noted are a user-entry key pad for entering designated desired searches (shown), a numeric display for various resultant searched numbers and values at 2, and a multiple user data entry link, generally at 3 for entering a desired most valuable terms, or otherwise prioritizing user search details as will also be discussed in detail.

FIGS. 2A through 2D denote a pictorial explanation of the specific data base pool, with related data base pools of telephone numbers that are possible (FIG. 2A), of that all-possible pool, a group of numbers are assigned to phone companies (FIG. 2B) as ‘numbers able to be assigned’ and this number is continuously updated, and is otherwise updated additionally by area code and by using the noted conventional telephone formats (it is understood that generally the phrase ‘telephone’ is used loosely for the format despite the actual ‘use’ a number fulfills (fax, pager, cell, Voip, etc.). Of this group of local phone company assigned numbers, a group is known to be already assigned and used by specific customers (FIG. 2C), then of the remaining assigned but unused numbers, each phone company (Sprint®, ATT®, etc.) controls only a small subsection of numbers (FIG. 2D) since numbers are continually being transferred between phone companies, between users etc. As a result, it will be understood that no other phone company tries to get unused numbers from any other company. Also, no other company tries to get numbers from current or past customers for new clients. No other phone company keeps track of all numbers not out yet (assigned) and notifies users (who employ the current system) when these numbers do become available or when they are assigned. It will be understood that each different local (local may mean regional or even nationwide, but refers generally to a specific telecommunications company) controls only a tiny fraction of the numbers assigned but not used by any customer.

Referring now to FIG. 3A, an exemplary process for establishing a possible value database 4A (e.g., ‘buckets’) for a designated key word (here for example a 7 digit key word such as ‘driver’) based on the frequency or number of times the word occurs in a search/scan created database multiplied by related factors (prefix/suffix, etc.) accessible by a processing system 10 via a database server 22 managed by a search management application 62 which is also in operative control of a front end and back end management application 62A. In steps, a process searches all words (here all seven letter words) on the internet, assigned a number relating to the frequency that key word occurs and stores such a frequency data in a step 6A (here ‘driver’ may have a frequency bucket value of say 18,000). Thereafter, management application 62 determines additional factors (here prefix values and suffix values on a designated range, here 0.0-1.0) such that e.g., ‘go’(with a prefix value of 0.80 and ‘driver’ (18,000*0.80=14,400) in a step 6B. Then the resulting numbers for key words are arrayed on a distribution curve for all words in a step 6C creating generally a popularity or frequency curve (typically a bell curve with very long ‘tails’). In a next step, the curve is divided into a finite number of ranges (for example six regions), and the outer most or (least useful frequent words) assigned a value of a conventional local phone company basic number purchase (e.g., $400 retail and about $200 wholesale), with the central ranges assigned a value up to a total max value of a rational purchaser, for example up to about $6,000, but can be any number in a relationship with the basic number purchase costs from the local phone company, such that a steep curve induces a higher value. Additionally, some numeric custom values for exceptionally rare or newly-unique key words may be manually assigned by a system operator within each respective area code. For example, the name of a common limo service such as ‘driver’ may suddenly have extra value because, for example, a famous sports person named ‘driver’ suddenly makes popular a sports-movement (e.g., spiking a ball) that is termed “driver”. In such a rare circumstance, a valuation factor may be manually enhanced (for example, from a normal $6,000 value to a special value of $18,000). Such manual value enhancements may be modified at any time by the number search management application 62. Thereafter, in a step 6E, all related frequency and valuation data is returned to the relationship database 4A for storage and ready access by management application 62.

Referring now to FIGS. 3B and 3C illustrations are provided for keyword frequency and later valuation. The graphical representations are illustrated but not numbered as their illustrations are discussed further as follows. Regarding keyword factors; all potential vanity uses with scores are put into one of 8 million buckets for each possible number. The ‘highest’ score is the ‘score of the particular bucket number. The system shows and keeps the top-5 vanity uses for each number. A factor multiplier for the area code is used to take into account a relative demand and value of a particular area code (212 being valuable, and less population area codes being less valuable). This process gives the value of each unique number. Another random factor used to add a number to a value is that an exact monetary value is discouraged and prevented so that other competitors cannot ‘scrape’ our values from the website presentations so readily. One random factor, as an example, is to link the number and value to a daily variable (e.g., a % change in the stock market prorated to a 0.01 impact, to avoid damage to the valuation number in big stock market moves). Other vanity factors and valuation factors may be provided within the scope and spirit of the present invention.

In one alternative valuation calculation, a polynomial equation could be provided as the sum of a plurality of valuation functions (see later tables). For example, a function F_{T} (function of the toll free status of a number), an F_{URL} (a function of the existence of a matching URL for a vanity keyword), or an F_{N} (a function of the numeric repeats in a vanity numeric code (e.g., 235-8877) would have a double repeat). Each of these valuation factors, as a function, could be incorporated into a total valuation polynomial without departing from the scope and spirit of the present invention.

Referring now to FIG. 3D, an exemplary process for establishing a Keyword Database 4 is provided which is accessible by a processing system 10 via a database server 22 (as will be discussed), and controlled by a search management application for determining when and how all related databases are established, managed, and accessed. As noted in this example, Keyword Relationship Database 4 is established by a process of searching all active domain names registered, step 5A, electronically ‘scraping’ each domain to select key words and the title and other characteristics of the site, step 5B. Thereafter, the search management application or a data processing center conducts a step 5C of reviewing the resulting word search and confirming relationship results for the keyword database. In a further step 5D, the management application designates and calculates a population/popularity of each data word search result. Each of the these steps may be modified without departing from the scope of the spirit intended to note the creation and maintenance of a keyword relationship database have detailed terms using recognized database structures and protocols. It will be recognized that the related-ness factor of some words or phrases may not be well determined by the process steps, and a management or user/manual determination must be applied in a step 5E, as shown. For example, some words (Google, Film-star, Yahoo etc.) may have initial very low relationship results, but because of popular use, a management element would manually determine a relatedness factor—e.g., a sudden change in a famous actor's name, a popular movie phrase, brand of a rapidly popular company (e.g., Apple)).

FIG. 4 is an upper level diagram of an exemplary proposed system of the present invention showing a host data processing center 10 and exemplary user nodes.

As noted in the exemplary system, the host data processing center 10 has a central processing unit 12 interoperatively linked to: a monitor 14; a keyboard 16; a printer 18; and, a mouse 20. Additionally, the host data processing center 10 is linked with a database server 22 operative to host multiple databases, database folders and files and the manipulation and use thereof.

The host data processing center 10 is linked 50 to one or more remote user nodes. It is contemplated that a remote node could be co-located with the host data processing center 10 if local needs require. It is also understood that the listed peripherals could be removed and/or additional peripheral devices could be included with the host data processing center 10 as system or local needs require, and that the system could be extended so that various nodes may be any type of accessible peripheral device (cell phone, personal digital assistant, tablet, portable computer, etc.). The linkage 50 can be through wireless or hardwire needs or a combination of both as network needs dictate. The linked data processing center and nodes can be part of a local area network (LAN), a wide area network (WAN), or as part of an interne or intranet network. Each of the (user) nodes will generally have a CPU 30 linked to: a monitor 32; a keyboard 34; a printer 38; and, a mouse 36. It is understood that the listed peripherals could be removed and/or additional peripheral devices could be included with the remote node as system or local needs require.

FIG. 5 is a block diagram of the host data processing center 10 having a CPU 60. The CPU 60 is interoperatively connected to: a management application 62 (shown here as a number search management application 62) which drives the system flow; a front end and back end management application 62A for updating and managing internal back-end and public-viewed interfaces, a memory 64; a monitor 66; a printer 68, a telecomm interface 70 for linking with remote nodes; a data input peripheral 72 such as a mouse or scanner; and, a possible co-located remote node 80. Memory 64 is further divided to store various living folders 82 in addition to the data bases required for system functionality. The living folders 82 are further subdivided into sub-folders 84a-n.

An important aspect of the present invention is the creation of the living folders 82 that can accept or transfer/donate data relative to each respective user's number search preferences, usage history on the application. The host data processing center 10 further comprises a data management routine for directing data to each of the sub-folders 84a-n in accordance with a pre-established set of criteria associated with each of the sub-folders.

In another alternative preferred embodiment of the present invention, the plurality of subfolders 84a-n includes a first sub-folder for storing general information about a user, including various user contact and user authentication and user historic data for past searches. Additionally, there may be: a second sub-folder for storing information related to a user's current phone company provider information, a user's preferences; a third sub-folder may be provided for storing details of said one or more prior searches and alternatively a user's prior and current search evaluation criteria (including any custom criteria established by a user); a fourth sub-folder for storing prior user search reports in whole or partial form; a fifth sub-folder for storing summary tables associated with a user's past behaviors; previously selected local numbers; a sixth sub-folder for storing summary tables associated with a user's wish list of desired numbers; a seventh sub-folder may be provided for a user's designated number escrow documentation; an eights sub-folder may be provided for storing prior and current provided wholesale valuations and retail valuations of numbers and vanity or word search results, and a ninth, and any subsequent, sub-folder(s) may be arranged to constitute a user's brokerage option for numbers not currently available, for various user requests, for user voice mail, and communications in respect of each of user details.

Turning next to FIG. 6, there is shown an exemplary system flowchart depicting an “authentication” workflow of the present invention for any particular user having any user designation status (new user, registered user, or any other system-designated user status based upon analyzing user behavior, as will be discussed.

Access to the authentication/re-authentication process begins from the system Sign-In page by advancing to the sign-in routine at step 150. From step 150, the system advances to the query at step 152 which asks if the user name and password have been entered. If the response to the query is “NO”, then the system displays a message to the user at step 160 and returns to the sign-in step at 150. If, however, the response to the query at step 152 is “YES”, then the system advances to the query at step 154 which asks if the user name exists. The system performs a match of the input with the names and passwords of approved users; and, if the name matches, then the system advances to the query at step 156. However, if the response to the query at step 154 is “NO”, then the system displays a message to the user at step 160 and returns to the sign-in step at 150.

Returning to step 156, if the user password matches a user password and name stored in database server 22 (FIG. 4), then the system advances to the query at step 158. However, if the response to the query at step 156 is “NO”, then the system displays a message to the user at step 160 and returns to the sign-in step at 150. At step 158, the system queries as to whether or not a new user is logging in. If the response to the query is “NO”, then the system advances to step 160 where the appropriate user settings are loaded for advancing at step 162 to access a home system portal for searching and presenting information according to a system designated user status, for example, including home/messages functionality as is shown in elsewhere herein. If the response to the query at step 158 is “YES”, however, then the system advances to step 164 which displays new registration instructions that direct the user to input their user and any desired financial credentials at step 166 (financial credentials may be held in abeyance according to the protocols established in number search management application 62, their contact information at step 168, and to complete the new user registration at step 170 before advancing along the path 172 to access the system at step 162 according to the system designated user status.

Additionally, where upon reaching step 158 a new user is provided with an optional, and very limited access, as a non-registered user along step 164A, thereby bypassing prior registration steps, and limiting further system functionality. It is proposed that alternative non-registered user access step 164A is a promotional portal, allowing first time users to access a limited number of search options or search reports before encouraging a non-registered user, desiring more access or further functionality, to register and become a registered user.

Returning to step 150, if the user does not have a password, or they have forgotten it, they are directed to step 174 where they enter their user name. The name is submitted, and the system queries as to whether or not the user name was entered. If the response to the query is “NO”, then the system displays an appropriate message and returns the user to step 174. If, however, the response to the query at step 176 is “YES”, then the system advances to the query at step 178 which asks if the user name already exists in the system database. If the response to the query is “NO”, then the system displays an appropriate message and returns the user to step 174. If the response to the query at step 178 is “YES”, however, then the system advances to step 182 where an identity confirmation question is posed to the system user. The user entry is submitted which advances the user to the query at step 184.

At step 184, the system queries as to whether or not the question posed at step 182 was answered by the user. If the response to the query is “NO”, then the system displays an appropriate message and returns the user to step 182. If the response to the query at step 184 is “YES”, then the then the system advances to the query at step 186 which asks if the response from the user at step 182 was correct. If the response to the query is “NO”, then the system displays an appropriate message and returns the user to step 182. If the response to the query at step 186 is “YES”, then the system generates an e-mail message to be sent to the user. The e-mail message includes the password for use by the user. The system then advances to step 192 where a confirmation of the transaction is displayed before the system advances along path 195 to return to the system flow and access the home system to search according to a system designated user status.

System 10 will include recognition in the databases and number search management application 62 that there are a number of different types of users, and the system conducts analysis steps to confirm and designate one of a series of ‘types’ of users that will allow system 10 to more readily respond to a user's needs. For example, some users search for numbers only in a user's local market while others search the same number nationwide. Still other users search for designated ‘most’ valuable terms in multiple industries, while some users focus within just one industry. Still other users may merely search for their company name while other search various company names repeatedly. Any and all of such search analytics may be used to create and modify profiles for different types of users. Types of user behaviors and searches that could be used create or designate a profile of user preferences are noted in Table I below.

TABLE I
User behavior factors to create or select proper profile for user preferences

| | |
|---|---|
| 1 | Registration Status (registered user or non-registered user; or |
| | adaptive premium-type users) |
| 2 | Industry Grouping |
| 3 | Geographic Grouping |
| 4 | Number of Nationwide Searches |
| 5 | Search Frequency (day, week, month, year, etc.) (noting past |
| | logs of searches, past queries of websites and searches) |
| 6 | Average Number of Searches per session |
| 7 | Number of Searches per Request |
| 8 | Frequency of Brand Names (identified trademarks, brands, |
| | etc.) in searches |
| 9 | Number of Nationwide Reports requested; types of reports |
| | requested |
| 10 | Number of Referrals (via optional number and user referral |
| | process) |
| 11 | Number of Activated Numbers |
| 12 | Number of Notification Requests |
| n | User custom defined factors |

The results and suggestions provided by the system provided will be based on or modified by the user's profile type. It will be recognized that the proposed system will include selectable drop-down selecting menus for various designations, such as ‘predetermined geographic grouping’ or a user's ‘specific industry’ and will not solely rely upon a blank-designation by a user or a user's actions (e.g., a number of tracked searches by a user). For example, a user only searching within one area code or one metro area will not wish to be shorn the same number or similar numbers to what they searched for in other area codes (without a user-so-designating). Users searching within a specific industry may be shown other related terms but only those within their designated industry. So, for example, if a user searches only for ‘lawyer’ repeatedly (known from the various living folders created for each user and retained for such use), when they search for ‘firm’ they will only be shown options related to a ‘law firm’, not options to ‘strong’ or ‘rigid’. Users that have an unusually high number of searches (as designated by search number management application 62) may be designated have a lower priority in search processing while users with a high number of activated numbers may receive more system designated options or benefits. The system may additionally transmit suggestions to users based upon new numbers that are provided or anticipated to be provided by management application 62. The suggestions system 10 sends users based on new numbers coming out can be based on a particular user type more than any user's immediate search results because the system recognizes that some users are less likely to be concerned about a number outside their industry or their geographic region.

We now discuss various aspects of the present method and system of the invention, including: (i) providing a phone number listing service, (ii) providing a service for conducting multiple searches cumulatively to determine ‘best number’ options for a user, (iii) allowing users to request numbers not yet assigned to phone companies in a sort of brokerage or wish list function, (iv) which relates to providing a connecting service to seek out and secure local numbers from existing customers and (v) provides an escrow service for existing numbers to enable transfer of funds to essentially support the transfer of a user-desired number.

Providing a phone number listing service that allows customers to list their existing phone numbers: The proposed system may search and provide customer information on behalf of designated users on the hosted telecom interface 70 and will forward information about the designated value of the number to those customers (understood to be users as well) and suggest that someone may be interested in their number. If the customer/user or holder of the number is interested they would then register separately on as a user and the proposed method and system would connect the interested parties or facilitating the exchange in some cases without disclosing either party's identify (a form of escrow arrangement). Initial visitors or even limited users, may be solicited to tell other users about the provided service and provided with an incentive for doing so, for example a coupon or cost reduction for registering or conducting other searches or being provided with an additional level of search detail.

Providing multiple searches cumulatively to determine best number options for a specific user based on details stored in the living folder 82, and number search management application 62. The proposed invention uses an alternative cumulative view to show more intelligence options for a user. For a non-limiting example, the last query entered can be given more ‘search’ weight when stored in the living folder 82 for a user, along with storage of a user's multiple queries in a the session and/or from their search history, of previous search sessions. For example, a user's search for ‘Driver’ might return options related to automotive operations, Limousine or chauffeur, but if their if previous searches were related to golf terms or computer component terms then a different set of possibilities would be suggested. Then each of the separate results from the living folder sub-folders are combined, multiplying the value by the number of times it appeared in the lists, and then the list is sorted by a designated importance value. This gives the most relevant numbers more value, elevating options related to several of the user's keywords (which may be intentionally designated or gleaned by the system from prior uses) as well as showing a more popular options first, making the system more responsive and appropriate to a user's desire. This view of user searches and requests can also extend to the area code(s) queried, to evaluate user needs, whether all of their queries are in one area code or whether they're spread across the country or just one regional area or metro area.

Providing a system allowing users to request numbers not yet assigned to phone companies in a sort of wish list function, which may be priorities, provided as an additional service-cost item. The proposed method and system using data processing center 60 and related folders and functions.

In process, the system provides two types of requests for numbers. First, the system allows customers to request “notification” of numbers that are not yet available and are not scheduled to become available in the foreseeable future. These requests are non-exclusive and are simply to be notified when a number we want does get scheduled to be assigned to a phone company, this allows a sort of ‘wish-list’ process to proceed over time. The wish list for a particular user type may be provided with an optional fee (a priority wish-list service that has options). Such priority wish list options may include the option of preventing any other user from receiving wish-list or other information about the designated wished-number, when it is available. Additional fees may further be priorities for access, different reporting structures, or other factors available to the system.

The proposed system also allows users (customers) to go a step further and to actually “Request” the system to try to activate a specified number for the user (customer), including a number that does not exist in an assignable number pool yet, but the system would see or recognized when such a number is scheduled to be assigned to a local phone company. These “Requests” are exclusive to a user (customer) and constitute a pre-order or a designation-order, rather than merely an inquiry or notification.

Also provided is a system for operative as a method for connecting or a connecting service to seek out and secure local numbers from existing customers known within the data base server 22 and system 10. This method attempts to get active customer numbers from existing phone number users for the systems customers. The proposed method and system provides the steps of contacting customers (via the phone, email and snail mail, text, etc.), showing a designated value for their number and directing the number owner to the hosted website and then to linking them with the party (user/customer) seeking their designated number. Multiple optional steps for such a method and system would include: (i) simply connecting the parties via electronic communication means, (ii) referring the parties to a designated outside party as a ‘neutral broker’, (iii) to handling the entire transfer process (transferring the number and the money for user/customers).

Additionally provided is an escrow service for local numbers, whereby system 10 allows user/customers to send payment (noting such payment details are in a designated live sub-folder for any user/customer) for a number, into an escrow system (an additional sub-folder) which will release the payment to a number seller after the number is confirmed to be transferred by local phone companies. The present invention provides such a phone number escrow service and method and monitors and administers the same. This creates a unique market and clearing house for phone numbers.

Additionally proposed now is a specific exemplary manner to display search results for a valuation method for providing a vanity or numeric priorities report that may be later valued values (wholesale or retail) based on valuation factors.

In an initial step (Step O) for a local valuation number process a Preparation for Query is performed by system 10, including the following query arrangements and assessments:

Step O (Preparation for Query)

Do we have any numbers to search in that owner/area code? (If Owner or area code is All, skip this step unless that's slower than doing it) If the quantity of numbers in that Owner and Area code is zero send “No Numbers” message and end.

Is query a numeric query consisting only of 000, *000, 0000, 00000, 1111, 2222, 3333, 4444, 5555, 6666, 7777, 8888, or 9999 (or ***-*000, ***-0000, **00000, ***-1111, ***-2222, ***-3333, ***-4444, ***-5555, ***-6666, ***-7777, ***-8888, or ***-9999). If yes, just show the best numeric options sorted by our vanity value, for that Owner and Area code, with no further searching message.

If query is numeric but not one of the numeric queries above, check to see if the digits match one of our keywords in our relationship database.

If so, continue using digits until step 4 when considering related terms.

In a first step (Step 1) for a local valuation number process, a basic block is assessed for all key words and phrases:

Step 1 (Basic Block Query, Also Done for all Keywords and Phrases)

Check for 8+ digit queries, without the 1st digit, then include if the 3rd digit of the area code is the first digit of the query. Repeat for 9 & 10+ digit terms with 1st two and three digits

Conduct Full 7 digit check

Skip phrases with a space after 8th position and any keywords or phrases over 12 digits long

Search for Prefixes (only for keywords, not for phrases)
4, 2, GO, TO, MY, 4A, OK, THE, GET, FOR, ALL, GOT, ONE, TOP, PRO, *GO, *MY, CALL, YOUR, OUR (for examples, all other and common suffixes included in database)

Search for Phrases only, try 4 and 2 in front of phrase

Search for Suffixes (only for keywords with 4 or 5 digits)
For example, LINE, CENTER, ONLINE, WORLD, GUY, 911, INFO, HELP, (similar suffixes in database)

In a second step (Step 2) Astrixes are provided for vanity numbers or phrases (not for anything with 7 or more digits)

Step 2 (Astrix Insert Search Conducted)

Check for related vanity results where a vanity or numeric search is done for anything with 6 or fewer digits and for desired related terms, for example:

***WORD and WORD***

**WORDS

*6WORDS and 6WORDS*, for non-limiting examples.

In a third step (Step 3) Astrixes are employed only for a specific original query, and not related terms.

Step 3 (Astrix Inserts Used for Only Original Query, not Related Terms)

Check for only the original query where there are seven digits or fewer, and employ astrix inserts, for example:

***WORDS

**6WORDS

*7DIGITS

In a fourth step (Step 4) determination that IF query is NOT in the previously generated, updated, and stored Keyword Relationship Database (See related FIGS. 3A-3D), wherein such database is generated initially from searching for all of the active domain names registered; each home page; electronic scrape to select key words and titles, reviewed resulting word result, confirming relationships of such, taking a full population/popularity of that data this gave us relationships, THEN skip to step 6. And, IF the query IS in the Keyword Relationship Database, then ‘Do a Basic Block’ above for each of the Keywords, Key Phrases, and Related Phrases requested (and designated) in the following order according to Table II.

Step 4 (Determination Re. a Basic Block Search) According to Table II

For every keyword we have 40 related keywords, 40 phrases that contain the keyword, and 40 phrases that do not contain the key term. The table (Table II) shows the order with which system 10 proceeds to check the 120 different terms (40+40+40=120). The goal is to make a search process smart enough to recognize and find the best keywords or numbers for a user in a huge pool of possible results, but also thorough enough to come up with reasonable options even in a small pool of possible results, if a user narrows the criteria, such as to one area code and/or to one phone carrier.

TABLE II

K1
K2
K3
P1
K4
K5
K6
P2
K7
K8
K9
X1
K10
K11
P3
K12
K13
P4
K14
K15
X2
K16
K17
P5
K18
K19
P6
K20
K21
X3
K22
K23
P7
K24
K25
X4
K26
P8
K27
X5
K28
P9
K29
X6
K30
P10
K31
X7
K32
P11
X8
K33
P12
K34
X9
P13
K35
X10
P14
K36
P15
X11
K37
X12
P16
X13
K38
X14
P17
K39
X15
P18
X16
P19
X17
P20
X18
X19
X20
P21
X21
P22
X22
P23
K40
X23
P24
X24
P25
X25
P26
X26
P27
X27
P28
X28
P29
X29
P30
X30
P31
X31
P32
X32
P33
X33
P34
X34
P35
X35
P36
X36
P37
X37
P38
X38
P39
X39
P40
X40
(K = Keyword (e.g. golf), P = Phrase that contains key word (e.g., golf course), X = Phrase without keyword (e.g., T—time))

In a fifth step (Step 5) conduct an Extra Block.

Step 5 (Extra Block)

If we do not have enough numbers yet (related words), searching for the terms related to the searched term can be done in an extra block search, e.g., searching to an additional level)

Do the following Extra Block for each of the Top 10 keywords for the Query. This gives you hundreds more terms when necessary.

Do the Extra Astrix search (Step 3).

Do the Basic Block search for the first 3 keywords of each of the top 10 keywords of the query.

In a sixth step (Step 6) prepare a ‘padding out’ of the results along the following parameters in preparing a report, and in storage into various living folder and subfolders for each query

Step 6 (Padding Out Results)

If we don't have enough good numbers or terms the system will incorporate additional terms to populate the AC.

Determination of IF the report has generated less than 1200 (a predetermined number by policy management application 62), then list all of the designated For Sale numbers within the desired area code.

Determination of IF we have less than 200 results (the concern being the search is overly narrowed), then add the best numbers identified (by popularity and population count) available within the area code identified by the predetermined vanity and numeric scores (sourced from our pre determined number value table (see following) for a selected area code of designated preferred words). The reasoning for such steps is that this process insures that the system displays a reasonable amount of numbers (for both registered users and registered users) to improve user convenience even when there is not a large number of results due to an initial-over narrowing of search results. If processing timed out because of a Results Check OR if the system reached the end of the last step in the related terms recipe (e.g., search process), or any custom made recipe (or search query process), then a step is provided to pass the code to the management application 62 to say there are no more pages available for that query. Otherwise the instructions to the system management application 62 are to pass the step in related terms stored in a designated living folder 82 that the system stopped at so the system can continue from that same position searching for more following the Results Check

Results Check:

If the system database searches do not get 50 results after processing for 3 seconds, then a step of skipping to Step 6 is conducted to expand out (pad out) results for user convenience.

Time Check:

Determine if 5 seconds have passed from the completion of an earlier step? If so skip to Step 6.

Quantity Check:

Determination if the system has generated a desired reporting number (here 1200 or more results), trim to a desired reporting number (1200) and return results of the query along the recipe for the next desired number for searching, if the user desires to continue searching.

It will be recognized that the phrase ‘recipe’ will also be understood as an operative control and search sequence provided by the number search management application 62 in operative connection with the living folder system 82 and memory 64 for a particular user, and the database server 22.

Numeric valuation factors are stored in system 10 in related databases in database server 22 and optionally in associated user living folders 82 for a particular user or a particular search process or historic references. Selected Numeric valuation factors for telephone number and vanity phrase results are noted in Table III, but are not limited thereto.

TABLE III
Valuation Factors for Telephone Numbers
(Factored for each of the possible (7) digit numbers and for
each of the 350+ area codes currently used)

| | |
|---|---|
| 1 | The number of search queries or requests for a specific telephone |
| | number or portion of a number on our site, and other related sites |
| 2 | Activation speed of a number in a new area code when such |
| | numbers are released, e.g., speed of 844 or 855 release, for example |
| 3 | Quantity of toll free telephone number searches or queries for a |
| | particular letter arrangement or numeral arrangement |
| 4 | Amount/volume of telephone numbers remaining in a particular area |
| | code |
| 5 | Amount of times a particular number shows up in a search engine |
| | search |
| 6 | Number of different vanity spellings possible for a particular |
| | telephone number; including: Value of particular vanity terms, |
| | Frequency with which vanity spellings/terms show up in marketing |
| | materials or online searches scrapped to form searchable |
| | databases yellow-page and white-page headings in data bases, |
| | company name registration frequencies |
| 7 | Number of area codes in which numbers are still available, historical |
| | log files of previously assigned files returned to carrier |
| 8 | Number of repetitive digits, numbers ending or containing zeros, |
| | calculation of required finger movement on 3 × 3/4 × 3 key pad, |
| | percentage of potential numbers already allocated, population base |
| | in or near an area code coverage area, number of businesses |
| | registered within or near an area code coverage area |
| 9 | Numeric alpha code brand and trademark registration recording and |
| | brand and trademark application |
| 10 | Prefix/Suffix correlations and factors to weigh each based on |
| | popularity of terms that combine well according to calculation |
| | recipe broken into (10) or more levels (e.g., where a very popular |
| | phrase or number will have a very high correlation factor, and a |
| | non-related phrase or number will have almost no correlation factor. |
| 11 | Determination if there is a matching domain name or similar domain |
| | name available or already reserved through a URL designated |
| | Registrar |
| N | Future identified factors |
| M | User custom defined factors through user interface provided |

As noted earlier in initial valuation discussion regarding FIG. 3A, and the related system additional valuation correlation factors may be considered in a formulaic manner.

Following a determination of valuation for a local number the related results and value are stored in live files (updateable databases and sub-folders) in living folder 82 for a particular search and user. It will also be understood that the valuations for local number results for prior searches are also linked and provided in database server 22 for related macro management by number search management application 62. As a result, system 10 provides an available numeric value for each number enterable into system 10 by a user. Where user designator is recognized as suitable as being a commercial entity or high-volume user, a discounted wholesale and a full retail valuation for a number are designated and available.

Referring now to FIGS. 7A to 7B flow charts depicting a generally integrated search process and activation process for a user designation with various optional outcomes according to the present invention.

In FIG. 7A a search process initiation 200 includes a step 201 for showing a wholesale value, retail value and most valuable vanity terms, a step 202 for allowing visitors to register current numbers and to export related steps 203-208 as noted in the chart in detail. It will be recognized that optionally each step and action taken by a user of any status may be maintained and updated to such a users living folder or multiple living sub-folders 82 so that system 10 provides for an integrated user search process that also tracks and retains information about the search that may be used in providing user specific results, or integrated into the overall management application of system 10.

In FIG. 7B alternative activation processes 208 are provided, each with the understanding that the related steps shown are all interlinked for tracking, updating, and record, and outputting from living folder or subfolders 82 for a particular user, particular activation process, particular local phone company, and other factors and features of the activation process and actions collectively noted at 208 and as described in step boxes 209A through 223 as shown in FIG. 7B.

Referring now to FIG. 8A through FIG. 8D wherein an exemplary Output Report for a registered user is provided where the user searches the number 201-Drivers (which is 201-374-8377) as a vanity number for ‘drivers’ (which may be related to autos, mechanical matters, or other related key words as discussed in detail above. As noted in FIG. 8A, an initial commentary is provided to the ‘user’ (here ‘Bill@tollfreenumbers.com’ or by a third party registered Agent). Next, via accessing the living folders to retrieve generated data relating to each section, an initial report of terms, vanity rank, numeral ranking, proposed monetary value, and alternative vanity terms is suggested. Next the report provides numerous summary details via a set of ‘hot links’ that provide the raw search results (see FIGS. 8B-8D for steps 1-5) and may also provide further informational details to the user for steps 7-9 of hot links. It will be recognized that in steps 1-5 the raw data is sourced from various databases stored in the developed sub-folders (82 (a-n)) in the living folders 82 for each respective user that are populated during use, retain searched results and user status and other details.

It will be recognized that in one aspect of the proposed invention a method and system is provided wherein numbers are provided as part of a marketing package that will include, at a desired minimum, a domain name and an additional logo in addition to the desired number. In this manner, adaptive marketing and promotional systems and methods are provided.

As will be noted in FIG. 8A and the ‘hot links’ region, section 6 provides a description of the ‘advantages of local numbers’ to users. These advantages include, but are not limited to:
a) No cost for incoming calls—incoming calls to a local number do not cost or have a very low cost. Costs for toll-free numbers are incurred for all incoming calls.
b) More good vanity options available for local numbers—100% of the 1-800 numbers are already in use, including a more recent area code (855). Toll free numbers are highly speculative in the numbers market, and the few that are free every month are gone quickly. A local number is more suitable for most businesses.
c) Local numbers accept text messages—a great tool for marketing
d) Local numbers work internationally—local numbers can be called from any location in the world which makes ‘local’ numbers better and necessary for many internet-related businesses. Toll free numbers typically are only accessible from within North America.
e) Local numbers have matching domain names readily available

In a section 7 an explanatory process is provided for finding local vanity numbers and operating as an Agent. The general steps include: (1) registering at the user profile links for the system. There is no charge to register but a referral from another agent is required. (2) Determination of a number for potential requesting and use, and the action of ‘requesting’ the local number (discussed earlier). (3) The system collects any request and contacts the local phone company with that number, this is accepted or rejected, and when accepted, the local company may reserve that number on a temporary account and sends it to a specific representative, and provides a reservation number and contact. That agent will set up an account in the customer's name. Alternatively, the proposed system may opt for a local phone company to initiate a transfer request to our designated phone company, where can set up a number for a customer, and then the customer may either begin immediate use of the number or further transfer that number away to a phone company of the customer's choice.

In a section 8 discussion is provide for how Agents could generate revenue through registration and reservation of local vanity numbers in several ways.

Referring now to FIG. 9, with several of the operations discussed, there is recognized a potential concern of a receiving local phone company (receiving a number that is transferred either from a different local phone company but reserved through the proposed invention or one that is newly assigned (in a block) to a local phone company but not yet assigned to any customer at all, for authenticity of the transfer and confirmation of the ‘origination’ of the number, ownership details, date of issuance or registration of the number to a specific user, customer, or agent. As a result, the proposed inventive method and system provides for issuance of a documented record of action, via a ‘certificate of authenticity’ or other document, that a user, customer, or agent may use to verify origination and ownership in any subsequent down-stream transfer. Such a step and feature (which may be stored in a living folder and remotely accessible via sign in functions) assists the expansion of the proposed system.

Referring now to FIG. 10, an exemplary New Watch sample input page is provided for a registered user, illustrating the types of data that could be included in such a user-desired watch or ‘wish list’ request.

It will be understood that the proposed method and system is similarly suitable for working throughout North America (not only the United States), and may be readily adopted for any foreign calling profiles in foreign countries without departing from the scope and spirit of the present invention.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A method for submission management of a telephone number request data by a data management processing system via a computer processor, said method comprising the steps of:
providing a plurality of computer instructions performed via a computer processor and memory chips of:
determining a valuation of one of a keyword and a telephone number based upon a valuation process and storing said telephone number valuation in a living folder comprising a plurality of subfolders associated with said computer processor for storing data relent to said step of determining a valuation;
authenticating, at a remote node a user status;
receiving one of a keyword and a phone number valuation request from a user;
determining a specific valuation request result for said user;
transmitting said specific valuation request result to said user;
storing a result of said specific valuation request in a user associated living folder;
accessing said user associated living folder and incorporating said user associated result for said specific valuation request into said living folder associated with said computer processor;
wherein said computer processor performs in parallel instructions of the steps of:
establishing a living folder for said computer processor and storing therein a determination of a valuation of said one of said keyword and said telephone number based upon said valuation process;
said living folder associated with said computer processor further comprising a plurality of sub folders for storing data relevant each said keyword and said telephone number;
authenticating at said remote node user's status;
receiving said one of a keyword and said phone number valuation request from said user;
determining a specific valuation request result for said user;
transmitting said specific valuation request result to said user;
storing a result of said specific valuation request in a user associated living folder; and
accessing said user associated living folder and incorporating said user associated result for said specific valuation request into said living folder associated with said computer processor.
